(19) United States
(12) Patent Application Publication
(10) Pub. No.: US 2009/0252150 A1
(43) Pub. Date: Oct. 8, 2009

(54) System and Method for Secure Transaction Routing on Demand

(75) Inventors: Devarajan Puthupparambil, Rolling Meadows, IL (US); J. Schneider, Grayslake, IL (US)

Correspondence Address: UTSTARCOM, INC., 3800 GOLF ROAD, SUITE 220, ROLLING MEADOWS, IL, 60008, US

(73) Assignee: UTStarcom, Inc, Alameda, CA (US)

(21) Appl. No.: 12/061,161

(22) Filed: Apr. 2, 2008

(51) Int. Cl. H04L 12/66

(52) U.S. Cl. 370/352

(57) ABSTRACT

A secure transaction routing system, which includes a transaction terminal for generating a routing type based on a message received from a transaction instrument, is provided. Many host servers that link to the transaction terminal through one or more communication gateways are also included. The communication gateways route a call session to at least one of the many host servers based on the routing type.

### BACKGROUND

The invention generally relates to Internet Protocol based transaction sessions, and more specifically, to a system and method for performing secure transaction routing on demand over an Internet Protocol based communication network.

Secure transaction routing over public Internet Protocol (IP) networks, between Internet Protocol Point-of-Sale (IP POS) terminals and host servers are made possible by aggregating Secure Sockets Layer (SSL) connections from IP POS terminals and routing them to the host servers. This transaction routing operation is performed by a communication gateway or a transaction gateway.

Current transaction routing solutions rely on pre-configured server addresses to perform the transaction routing or data forwarding to destination host servers. In other words, the service providers have to configure the POS terminals with the destination addresses or the Domain Name System (DNS) names. Moreover, additional configurations are required at the transaction gateway units to route the incoming connections from the POS terminals to the destination host servers.

It can therefore be readily understood that in order to initiate a new service, the POS terminals need to be configured appropriately to communicate with a pre-configured transaction gateway which will then route the session to the intended destination based on the configuration. This significantly inhibits the possibility of termination of a transaction initiated by any POS terminal on any available transaction gateway, which could accordingly route the transaction to any intended host server.

There is therefore a need for techniques to provide routing capabilities to the various components in an IP-based transaction routing system in order to effectively utilize the system.

### SUMMARY

According to one aspect of the present techniques, a secure transaction routing system is provided. The transaction routing system includes a transaction terminal for generating a routing type based on a message received from a transaction instrument. Many host servers that link to the transaction terminal through one or more communication gateways are also included. The communication gateways route a call session to at least one of the many host servers based on the routing type. A method for transaction routing is also provided.

According to another aspect of the present techniques, a system for secure transaction routing is provided. This transaction routing system includes a transaction terminal for inserting a record to a call data based on a message received from a transaction instrument. Many host servers linked to the transaction terminal via one or more communication gateways are also included in the system. The communication gateways route the call data to at least one of the many host servers based on the record in the call data.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary IP-based transaction processing system, in accordance with aspects of the present techniques; and

FIG. 2 is a block representation of a message format of a transaction request data to be used in the IP-based transaction processing system, in accordance with aspects of the present techniques.

### DETAILED DESCRIPTION OF EXEMPLARY EMBODIMENTS

In the following paragraphs, an approach for routing secure transactions on demand, over an Internet Protocol (IP) based communication network will be explained in detail. The architecture and the approach described hereinafter presents a technique for securely routing IP-based transactions over the Internet. Such transaction routing is performed with an IP-based Point-of-Service (IP POS) terminal where the transaction is initiated and routed to communication gateways and subsequently to host servers. An IP POS terminal as used in this context may be defined as a transaction terminal facilitating different types of electronic transactions, which may include, in one embodiment, a Point-of-Sale terminal that is commonly used to retail credit or debit transactions. The transactions performed over the IP POS terminals and the IP-based networks are processed securely via the use of various IP protocols, transaction protocols, and, security or authentication and authorization protocols. As will be appreciated by those of ordinary skill in the art, the technique is applicable to various systems that perform secure transactions over IP-based networks. Indeed, the exemplary uses and implementations described herein are merely provided as examples to facilitate understanding of the presently contemplated techniques. Therefore, the various aspects of the present technique will be explained, by way of examples only, with the aid of figures hereinafter.

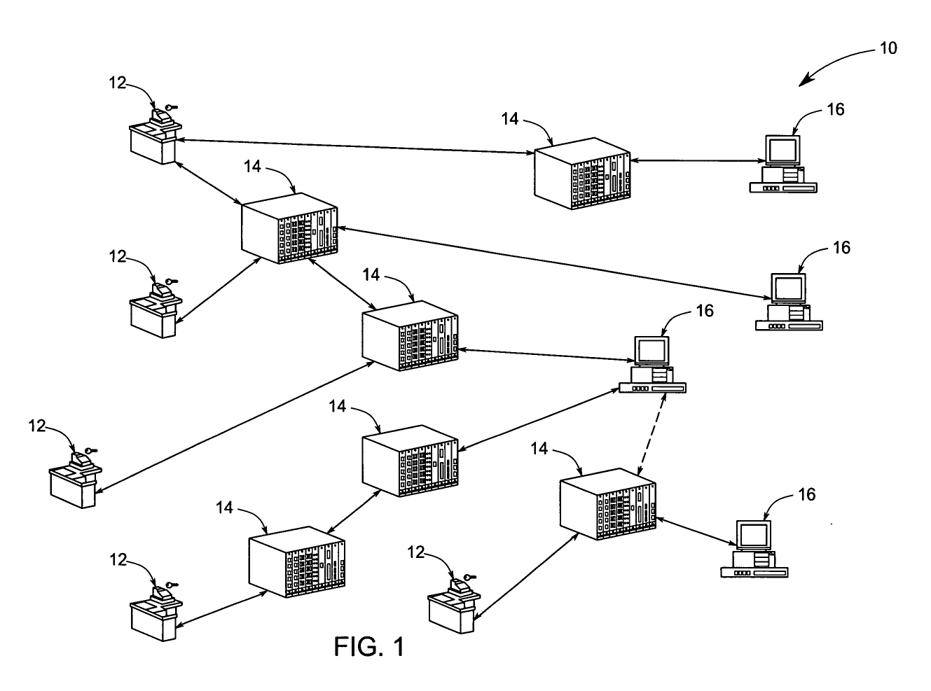

Referring generally to FIG. 1, the transaction processing and routing process will be described by reference to an exemplary IP-based transaction processing system designated generally by numeral 10. It should be appreciated however, that the transaction processing system 10 may find application in a range of settings and systems, and that its use in transaction processing described herein is but one such application. As will be explained in detail, the transaction processing system 10 is employed in various kinds of applications ranging from simple POS transactions to more complex communications, such as for example, a secure access, a secure message exchange between two devices, and the like.

The transaction processing system 10 includes IP POS transaction terminals 12 deployed at various retail locations, communication gateways or transaction gateways 14 arranged across regions, and host servers 16 positioned at specific locations. The transaction terminals 12 are communicatively coupled to communication gateways 14 through a secure public network or a private network, such as but not limited to a Secure Sockets Layer (SSL) network over the Internet or an Internet Protocol Security (IPSec) connection. Various communication gateways 14 may be communicatively coupled to each other over a secure public network, such as the Internet, via secure protocol links like IPSec connections. Many communication gateways 14 are further communicatively linked to host servers 16 over a secure private network, such as via a simple socket connection like Transmission Control Protocol (TCP) socket connection, a Transmission Control Protocol/Internet Protocol (TCP/IP) network, a non-secure connection, or over a private network.

Each of the IP POS transaction terminals 12, deployed at various establishments, such as shops, are capable of accepting or performing a financial transaction through a credit card, a debit card, or any such financial instrument as may be contemplated by one of ordinary skill in the art. Similarly, the transaction terminal 12 is also capable of handling other transactions such as a secure access or a secure message exchange. The various communication gateways 14 are preferably configured to convert an incoming communication that uses a certain transaction protocol into an aggregated outgoing communication that uses the host-compatible transaction protocol in Layer 7. Therefore, it serves to facilitate compatible communication exchanges between multiple end users (such as various IP POS terminals 12) and, for example, an authorization host or the host server 16.

The host server 16 may similarly include a host socket connection, which links to the communication gateway 14 and facilitates provision of the abovementioned outgoing communication that is aggregated with respect to Layer 3. Those skilled in the art would recognize that a range of other IP protocols or socket connections may be utilized, such as but not limited to Network Time Protocol (NTP), User Datagram Protocol (UDP), Domain Name System (DNS), Lightweight Directory Access Protocol (LDAP), Routing Information Protocol (RIP) and its IP versions of RIP, RIPv1, RIPv2, and RIPng, Open Shortest Path First (OSPF), as presently known, or others hereafter developed. The transaction protocols supported by the communication gateway 14, in order to conduct a transaction, includes VISAI (EIS 1051), VISAII (EIS 1052), ISO 8583, Transport Protocol Data Unit (TPDU), Transparent protocol, and, various custom protocols as are known in the art to facilitate interaction between host servers 16 and IP POS terminals 12.

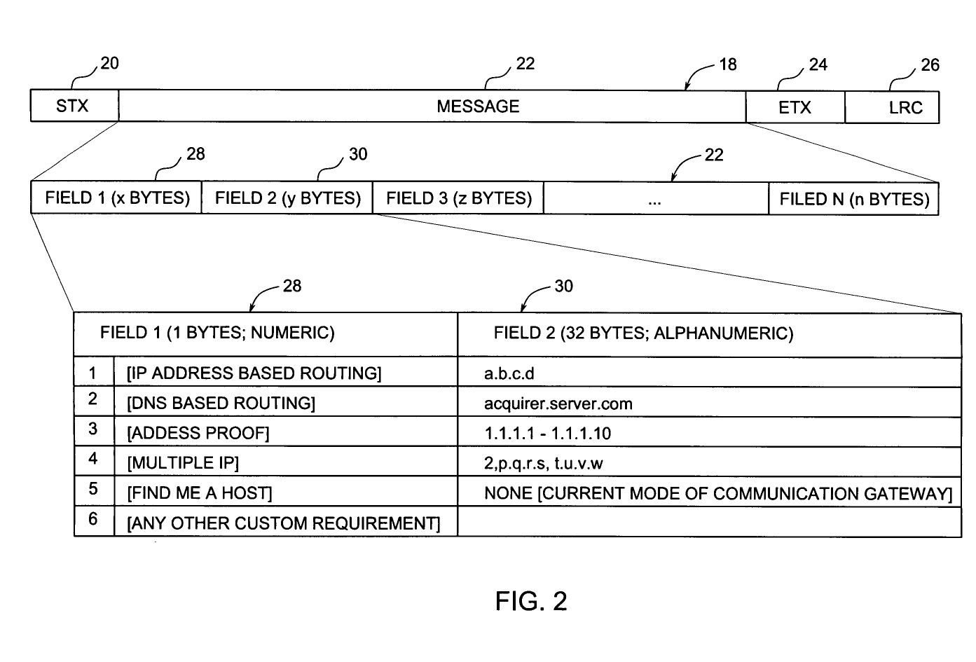

In one embodiment, various IP POS terminals 12 are deployed at different retail locations. Each of these is in communication with one or more communication gateways 14. These communication gateways 14 are in turn communicatively linked to host servers 16. Therefore, a transaction or a call session initiated at an IP POS terminal 12 by a transaction instrument will be routed through a communication gateway 14 and the communication gateway will then route the transaction data to a host server 16. However, the transaction processing system 10 may also include a tiered architecture. For example, once an IP POS terminal 12 initiates a transaction, the transaction data can be routed to a Tier 1 communication gateway 14. Depending on various factors and preferences, such as but not limited to specific host servers that the Tier 1 communication gateway 14 would communicate with, the transaction data may then be routed to a Tier 2 communication gateway 14, selected from a multitude of communication gateways. In other words, a Tier 1 communication gateway 14 may be linked to multiple Tier 2 communication gateways 14, and multiple Tier 1 communication gateways may be linked to a Tier 2 communication gateway. Such routing facilitates establishment of an optimal route or a least cost path. In all the above cases, and others contemplated hereafter, any IP POS terminal 12 can communicate with any of the communication gateways 14, which in turn can communicate with any of the available host servers 16 as described below. The selection of the appropriate communication gateway 14 and host server 16 for a particular transaction routing will, in such cases, be done dynamically depending on various factors, as will be explained below with reference to FIG. 2.

FIG. 2 is a block representation of a message format of the transaction request data that is used in the IP-based transaction processing system. The message format of the data packet generally represented by numeral 18 includes a 1 byte long Start-of-text STX field 20 that indicates the start of the message block, a variable length Message block 22 that comprises the data, and a 1 byte long Termination Character ETX 24 indicating the end of the message block. A Longitudinal Redundancy Check LRC field 26 is used to include an LRC character that is generated and appended to all data packets for detection and recovery from transmission errors that might result from any line interference. This LRC is an 8-bit EXCLUSIVE-OR of all bytes starting with the byte after STX and including the final ETX of the message.

The Message block 22 includes a number of fields, for example Field −1 to Field −N, each having their respective lengths, as shown in the expanded block. In an embodiment of the presently contemplated techniques, out of these various fields, Field −1 28 and Field −2 30 includes contents as defined below. Field −1 28 is 1 byte in length and includes a numeric character, while Field −2 30 is 32 bytes in length and includes an alphanumeric character. Field −1 28 provides a description of the value of the contents by indicating the type of address specification or a routing type as the record in the call data, and, Field −2 30 indicates the actual address string containing alphanumeric characters. For example, when Field −1 28 contains “1” indicating an IP address-based routing to the IP POS terminal 12, Field −2 30 contains the actual IP address “a.b.c.d” of the host server 16. Similarly, when the IP POS terminal suggests a DNS-based routing preference, indicated by a “2” in Field −1 28, Field −2 30 would include a DNS address of the host server 16, such as “acquirer.server.com”. Again, Field −1 28 may include other types of address specifications like an address pool, indicated by a “3” where the corresponding Field −2 30 would include a range of preferred IP addresses of the host servers 16, such as 1.1.1.1 to 1.1.1.10. It would be appreciated by one of ordinary skill in the art that Field −1 may also include multiple IP addresses for the IP POS terminal 12 and the communication gateway 14 to dynamically find the most preferred host server 16. Such a host server 16 search technique may be beneficial when the transaction, IP POS terminal, or the communication gateway 14, prefers to route the transaction to any host server without any inherent preference. In other words, this ‘Multiple IP’ technique indicated in Field −1 28 by “4” can include multiple IP addresses, such as “2”, “p.q.r.s”, or “t.u.v.w” in Field −2 30. Furthermore, a ‘Find me a host’ technique may also be employed in which the Field −1 28 indicates the numeral “5”, while Field −2 30 is dynamically updated based on the current mode of the communication gateway 14.

As will be appreciated by one of ordinary skill in the art, any custom requirement can also be specified, as indicated by a “6” in Field −1 28, where the Field −2 30 would be updated based on the custom requirement and may include a user-defined parameter. Moreover, any combination of the types of addresses may also be used where Field −1 28 can indicate a “6” or other such value, while Field −2 30 would indicate the combination of the different addresses. Thus, Field −1 28 indicates the routing type based on the transaction or the call and Field −2 30 indicates the preferred category of the host server 16. Based on these fields in the message block 22 of the data packet 18, the IP POS terminal 12 can indicate the preference of the transaction or call session to be routed to any of various communication gateways 14, which in turn can route the call data to the appropriate host servers 16. Various other modifications can also be contemplated by those of ordinary skill in the art.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A secure transaction routing system, comprising:
at least one transaction terminal configured to generate a routing type based on a message received from a transaction instrument; and
a plurality of host servers communicatively coupled to the at least one transaction terminal via one or more communication gateways, wherein the one or more communication gateways are configured to route a call session to at least one of the plurality of host servers based on the routing type.

2. The secure transaction routing system of claim 1, wherein the at least one transaction terminal comprises a Point-of-Service transaction terminal.

3. The secure transaction routing system of claim 1, wherein the at least one transaction terminal is configured to determine a preferred category based on the message received from a transaction instrument, and wherein the routing type is generated based on the preferred category.

4. The secure transaction routing system of claim 1, wherein the routing type comprises at least one of a plurality of IP addresses, a DNS name, or a combination thereof.

5. The secure transaction routing system of claim 1, wherein the routing type comprises a random selection of a host server address based on a mode of the at least one communication gateway.

6. The secure transaction routing system of claim 1, wherein the routing type comprises a user-defined parameter.

7. The secure transaction routing system of claim 1, wherein the call session comprises the routing type.

8. The secure transaction routing system of claim 1, wherein the at least one transaction terminal is communicatively coupled to the one or more communication gateways over a secure public network.

9. The secure transaction routing system of claim 1, wherein one or more communication gateways is communicatively coupled to at least one of the plurality of host servers either via a secure socket connection or over a private network.

10. A method for transaction routing, the method comprising:
initiating a call session using a transaction instrument at a transaction terminal;
generating a routing type for the call session based on a message received from the transaction instrument; and
identifying a host server for termination of the call session, at a communication gateway, and routing the call session to the host server via the communication gateway over either a secure public network or a private network based on the routing type.

11. The method of claim 10, wherein generating the routing type comprises determining a preferred category based on the message received from the transaction instrument.

12. The method of claim 11, wherein generating the routing type comprises generating the routing type based on the preferred category.

13. The method of claim 10, wherein identifying the host server comprises identifying the host server based on at least one IP address.

14. The method of claim 10, wherein identifying the host server comprises identifying the host server based on a DNS name.

15. The method of claim 10, wherein identifying the host server comprises identifying the host server based on a combination of at least one IP address and a DNS name.

16. The method of claim 10, wherein identifying the host server comprises identifying the host server based on a random selection of a host server address, wherein the random selection is based on a mode of the communication gateway.

17. The method of claim 10, wherein identifying the host server comprises identifying the host server based on a user-defined parameter.

18. A system for secure transaction routing, comprising:
a transaction terminal configured to insert a record to a call data based on a message received from a transaction instrument; and
a plurality of host servers communicatively coupled to the transaction terminal via one or more communication gateways, wherein the one or more communication gateways are configured to route the call data to at least one of the plurality of host servers based on the record in the call data.

19. The system of claim 18, wherein the record comprises at least one of an IP address, a DNS name, a host server identifier, a user-defined parameter, or a combination thereof.

20. The system of claim 18, wherein the one or more communication gateways are configured to identify the at least one of the plurality of host servers based on the record for transmission of the call data.
